(19) United States
(12) Patent Application Publication
(10) Pub. No.: US 2021/0260452 A1
(43) Pub. Date: Aug. 26, 2021

(54) MULTILAYER COMPOSITE PICKLEBALL RACKET

(71) Applicant: DONGGUAN XINSHUO COMPOSITE MATERIAL TECHNOLOGY CO., LTD., Dongguan (CN)

(72) Inventor: Tongliang ZHENG, Dongguan (CN)

(21) Appl. No.: 17/315,306

(22) Filed: May 8, 2021

(30) Foreign Application Priority Data
Jan. 25, 2021 (CN) 202110097904.0

(51) Int. Cl. A63B 59/42; B32B 27/32; B32B 3/12; B32B 27/08

(52) U.S. Cl. CPC A63B 59/42; B32B 27/32; A63B 2209/02; B32B 27/08; B32B 2307/732; B32B 3/12

(57) ABSTRACT

The present invention relates to a multilayer composite pickleball racket, including a board and a handle. The handle is connected to the board; a composite filler layer is arranged inside the board and at least includes a first filler layer and a second filler layer; the first filler layer is adhered to the second filler layer; and the first filler layer and the second filler layer are both provided with honeycomb structures. The multilayer composite pickleball racket is combined by a plurality of filler layers of different materials, so that the structural features such as intensity, sound and hardness of the board are changed, different hitting sounds and hitting handfeels are generated, the usage experience of sports enthusiasts is improved, and the interestingness is increased.

### CROSS-REFERENCE TO RELATED APPLICATIONS

This application claims the benefit of priority from Chinese Patent Application No. 202110097904.0, filed on Jan. 25, 2021. The content of the aforementioned application, including any intervening amendments thereto, is incorporated herein by reference in its entirety.

### TECHNICAL FIELD

The present invention relates to the technical field of rackets, and particularly relates to a multilayer composite pickleball racket.

### BACKGROUND OF THE PRESENT INVENTION

Pickleball is a sport of hitting balls with a racket. It emerged from the Bembridge Island in Seattle, USA. It is a mixed sport of tennis, badminton and table tennis. In terms of physical activity level and motion range, pickleball is more relaxed and enjoyable than badminton and table tennis and has high flexibility, so it is more suitable for physical exercises than badminton and table tennis. Furthermore, the motion range and the amount of exercise of pickleball are less than those of table tennis, so that tennis enthusiasts that are not used to playing tennis and feel physically exhausted fast are suited to play pickleball and take it as an exercise program that involves regular exercise. Pickleball is suitable for people in all ages. About 2.5 million people in the United States play this sport year-round, and it has become a regular part of high school physical education classes.

However, the existing pickleball racket has a simple structure, and a racket filler is often made of a single material, which can only reflect one property and handfeel of the material itself, reduces the usage experience of sports enthusiasts and is lack of interest. Therefore, there are certain defects.

### SUMMARY OF THE PRESENT INVENTION

In view of this, it is necessary to provide a multilayer composite pickleball racket with respect to the technical problem that the existing pickleball has simple structure. A composite layer is formed by combining different filler materials to generate different hitting sounds and hitting handfeels to improve the usage experience of sports enthusiasts and increase the interestingness.

In order to achieve the purpose of the present invention, the present invention adopts the following technical solution:

A multilayer composite pickleball racket includes a board and a handle. The handle is connected to the board; a composite filler layer is arranged inside the board and at least includes a first filler layer and a second filler layer; the first filler layer is adhered to the second filler layer; and the first filler layer and the second filler layer are both provided with honeycomb structures.

The multilayer composite pickleball racket of the present invention is combined by a plurality of filler layers of different materials, so that the structural features such as intensity, sound and hardness of the board are changed, different hitting sounds and hitting handfeels are generated, the usage experience of sports enthusiasts is improved, and the interestingness is increased.

In one of the embodiments, the material of the first filler layer includes one of aramid, polypropylene, aluminum alloy and polymethacrylimide foam, and the material of the second filler layer includes one of aramid, polypropylene, aluminum alloy and polymethacrylimide foam; and the material of the first filler layer is different from the material of the second filler layer to form the composite filler layer.

In one of the embodiments, the material of the first filler layer is aramid to form an aramid honeycomb structure, and the material of the second filler layer is polypropylene to form a polypropylene honeycomb structure.

In one of the embodiments, a honeycomb side length of the aramid honeycomb is 1.8 mm or 2 mm, and a honeycomb diameter of the polypropylene honeycomb is 6 mm or 8 mm.

In one of the embodiments, a rubber layer or a fiber layer is arranged on the outer side of the board, and wrapped on the outer side surface of the composite filler layer.

In one of the embodiments, the handle includes an engagement part and a handheld part; the engagement part is connected to the top end of the handheld part; the engagement part is connected to the bottom end of the board; and a reinforcement rib is arranged at a joint of the engagement part and the board.

### BRIEF DESCRIPTION OF THE DRAWINGS

FIG. 1 is a schematic diagram of a multilayer composite pickleball racket according to a first preferred implementation mode of the present invention;

FIG. 2 is a structural schematic diagram of a composite filler layer of FIG. 1; and

FIG. 3 is a structural schematic diagram of a composite filler layer according to a second preferred implementation mode of the present invention.

### NUMERALS IN THE DRAWINGS

100: multilayer composite pickleball racket;
10: board; 11: rubber layer; 20: handle; 21: engagement part; 22: handheld part; 30: composite filler layer; 31: first filler layer; 32: second filler layer; 33: aramid honeycomb; 34: polypropylene honeycomb; 40: third filler layer.

### DETAILED DESCRIPTION OF THE PRESENT INVENTION

In order to facilitate the understanding of the present invention, the present invention will be described below more comprehensively. However, the present invention can be implemented in many different forms and is not limited to the embodiments described herein. On the contrary, the purpose of providing these embodiments is to make the understanding of the disclosure of the present invention more thorough and comprehensive.

It should be noted that when an element is called as being “fixed to” another element, the element can be directly on another element or a central element may be present. When an element is considered to be “connected” to another element, the element can be directly connected to another element or a central element may be present at the same time.

Unless otherwise defined, all technical and scientific terms used herein have the same meanings as commonly understood by those skilled in the art of the present invention. The terms used in the description of the present invention herein are only for the purpose of describing specific embodiments, and not intended to limit the present invention.

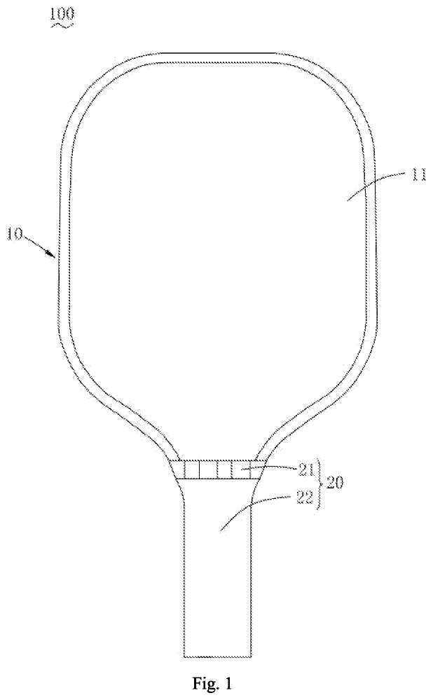

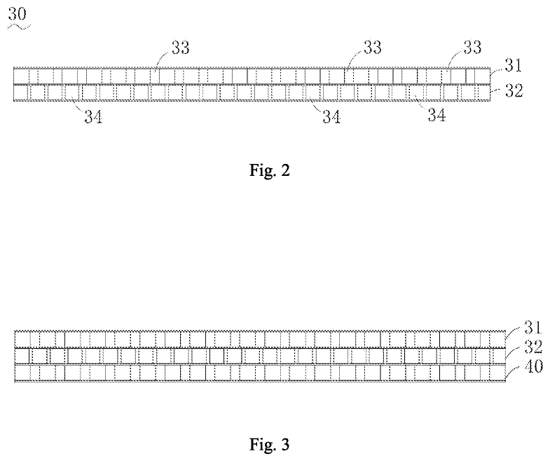

Referring to FIG. 1 to FIG. 2, a multilayer composite pickleball racket 100 according to a first preferred implementation mode of the present invention is illustrated, which includes a board 10 and a handle 20. The handle 20 is connected to the board 10; a composite filler layer 30 is arranged inside the board 10; the composite filler layer 30 least includes a first filler layer 31 and a second filler layer 32; the first filler layer 31 is adhered to the second filler layer 32; and the first filler layer 31 and the second filler layer 32 are both provided with honeycomb structures.

In the present embodiment, the first filler layer 31 is adhered and fixed to the second filler layer 32 in a film adhesion manner. In other embodiments, the first filler layer 31 is adhered and fixed to the second filler layer 32 by coating an epoxy glue. It can be understood that the adhesion between the first filler layer 31 and the second filler layer 32 is not limited. It should be ensured that the first filler layer can be tightly connected to the second filler layer to avoid a looseness phenomenon of the composite filler layer 30 in a use process.

Further, the material of the first filler layer 31 includes one of aramid, polypropylene, aluminum alloy and polymethacrylimide foam, and the material of the second filler layer 32 includes one of aramid, polypropylene, aluminum alloy and polymethacrylimide foam; and the material of the first filler layer 31 is different from the material of the second filler layer 32 to form the composite filler layer, so as to ensure that the composite filler layer contains different filler materials to generate different hitting effects. Polymethacrylimide (PMI) is crosslinked foam with uniformly distributed foam, which has excellent structural stability and high mechanical strength. Correspondingly, a PMI honeycomb has good durability and environmental resistance.

In the present embodiment, the material of the first filler layer 31 is aramid to form an aramid honeycomb structure, and the material of the second filler layer 32 is polypropylene to form a polypropylene honeycomb structure. Specifically, a honeycomb side length of the aramid honeycomb 33 is 1.8 mm or 2 mm, wherein the aramid honeycomb 33 is relatively hard and relatively small, so that a racket made by it has large hitting sound and relatively high hardness. A honeycomb diameter of the polypropylene honeycomb 34 is 6 mm or 8 mm, wherein the polypropylene honeycomb 34 is relatively soft and has relatively large honeycomb holes, so that a racket made by it has low hitting sound, relatively low intensity and relatively low hardness. In other embodiments, the honeycomb side length of the aramid honeycomb 33 and the honeycomb diameter of the polypropylene honeycomb 34 can be correspondingly adjusted and used according to different production conditions.

Further, a rubber layer or a fiber layer is arranged on the outer side of the board 10, and wrapped on the outer side surface of the composite filler layer 30 to realize skin covering treatment for the composite filler layer, so that the protection performance of the composite filler layer 30 is improved, the service life is prolonged, and the phenomenon that the composite filler layer is damaged because it is exposed to an external environment for a long period of time is avoided. In the present embodiment, the rubber layer 11 is arranged on the outer side of the board 10. In other embodiments, the fiber layer may be arranged on the outer side of the board 10.

Further, the handle 20 includes an engagement part 21 and a handheld part 22; the engagement part 21 is connected to the top end of the handheld part 22; the engagement part 21 is connected to the bottom end of the board 10; and a reinforcement rib is arranged at a joint of the engagement part 21 and the board 10, thereby improving the connection firmness between the handle and the board and avoiding the looseness or falling phenomenon of the handle in a hitting process.

Referring to FIG. 3, a multilayer composite pickleball racket according to a second implementation mode of the present invention is illustrated. The present embodiment differs from the first embodiment in that the composite filler layer 30 further includes a third filler layer 40, wherein the first filler layer, the second filler layer and the third filler layer 40 are stacked and adhered in sequence, thereby realizing structural setting of the composite filler layer, promoting the intensity, the sound and the hardness of the board to correspondingly change and increasing the experience of a user. In the present embodiment, the material of the third filler layer 40 is the same as that of the first filler layer. In other embodiments, the material of the third filler layer 40 may be the same as that of the second filler layer, or may be other materials different from the first filler layer and the second filler layer, so as to ensure that the composite filler layer has two or more different materials.

It can be understood that in other embodiments, the composite filler layer of the board may be a double-layer composite structure, or a three-layer composite structure, or a composite structure including three or more layers. It should be ensured that the composite filler layer has two or more different materials. Boards with different composite layers can be produced according to different actual needs and market interests. Different filler materials are mixed and interlaced to achieve a complementation effect between filler materials, so that the racket generates a different sound and handfeel experience, which makes more sports enthusiasts to enjoy this sport and improves the practicability and usage scenario.

The multilayer composite pickleball racket of the present invention is combined by a plurality of filler layers of different materials, so that the structural features such as intensity, sound and hardness of the board are changed, different hitting sounds and hitting handfeels are generated, the usage experience of sports enthusiasts is improved, and the interestingness is increased.

The technical features of the above embodiments can be combined arbitrarily. In order to make the illustration concise, all possible combinations of the technical features in the above embodiments are not described. However, as long as there is no contradiction in the combinations of these technical features, the combinations should be considered as the scope of this description.

The above embodiments only express several implementation modes of the present invention, and are described relatively specifically and in detail, but they shall not be interpreted as limiting the scope of the invention patent. It shall be indicated that for those ordinary skilled in the art, several modifications and improvements can be made without departing from the concept of the present invention, and shall belong to the protection scope of the present invention. Therefore, the protection scope of the invention patent shall be subject to the appended claims.

1. A multilayer composite pickleball racket, comprising a board and a handle, wherein the handle is connected to the board; a composite filler layer is arranged inside the board and at least comprises a first filler layer and a second filler layer; the first filler layer is adhered to the second filler layer; and the first filler layer and the second filler layer are both provided with honeycomb structures.

2. The multilayer composite pickleball racket according to claim 1, wherein the material of the first filler layer comprises one of aramid, polypropylene, aluminum alloy and polymethacrylimide foam, and the material of the second filler layer comprises one of aramid, polypropylene, aluminum alloy and polymethacrylimide foam; and the material of the first filler layer is different from the material of the second filler layer to form the composite filler layer.

3. The multilayer composite pickleball racket according to claim 2, wherein the material of the first filler layer is aramid to form an aramid honeycomb structure, and the material of the second filler layer is polypropylene to form a polypropylene honeycomb structure.

4. The multilayer composite pickleball racket according to claim 3, wherein a honeycomb side length of the aramid honeycomb is 1.8 mm or 2 mm, and a honeycomb diameter of the polypropylene honeycomb is 6 mm or 8 mm.

5. The multilayer composite pickleball racket according to claim 1, wherein a rubber layer or a fiber layer is arranged on the outer side of the board, and wrapped on the outer side surface of the composite filler layer.

6. The multilayer composite pickleball racket according to claim 1, wherein the handle comprises an engagement part and a handheld part; the engagement part is connected to the top end of the handheld part; the engagement part is connected to the Bottom end of the board; and a reinforcement rib is arranged at a joint of the engagement part and the board.
